(19) United States
(12) Patent Application Publication
(10) Pub. No.: US 2026/0041533 A1
(43) Pub. Date: Feb. 12, 2026

(54) Sonication Wand

(71) Applicant: Dentovations Inc., Tampa, FL (US)

(72) Inventors: David Wuchinich, Bronx, NY (US); Damon Brown, Boston, MA (US)

(21) Appl. No.: 18/799,728

(22) Filed: Aug. 9, 2024

Related U.S. Application Data
(60) Provisional application No. 63/532,313, filed on Aug. 11, 2023.

(51) Int. Cl. A61C 17/20

(52) U.S. Cl. CPC A61C 17/20

(57) ABSTRACT

Dental treatment device includes a wand having an applicator. A neck connector is provided between the wand and the applicator. An ultrasonic resonator; is provided and the ultrasonic resonator generates ultrasonic vibration in the applicator. The applicator generates ultrasonic vibration of a surface of an open cell foam. The open cell foam being impregnated with a solution and placed in contact with a surface of an individual human tooth.

### PREFACE

Sonication refers to the use of applying a surface made to vibrate with contact into another medium using compression-rarefaction wave propagation. The medium could be a solid, liquid or gaseous material or a combination of any of these materials. Typically in many practical applications the medium is a liquid. If the strength of the vibrating surface pushing against and then retracting from the medium is sufficient it may produce cavitation in the liquid, which is the formation, in concert with the frequency of the vibration, of microscopic vapor bubbles of the liquid that form as the vibration reduces pressure in the liquid in the rarefaction part of the vibration cycle. These bubbles then collapse as the vibration then produces increased pressure in the medium in compression part of the cycle. The gaseous bubbles produced by cavitation have been found when collapsing to produce extreme pressures capable of piercing the walls of biological cellular material, allowing the contents of these cells to be examined without further destructive effect as the cells'contents passes the vibration without altering them. Sonication is now a common laboratory method for examining the content of biologic cellular specimens.

Cavitation has also been found to accelerate chemical reactions, producing reaction rates far higher than those that would occur otherwise. This field of exploration has been namely sonochemistry and is an active area of study. Extensive investigations have to made to determine how cavitation produces such dramatic effects, leading investigators to believe that the incandescent temperatures and extraordinary pressures produced by the collapse of the bubbles, while confined to the microscopic bubble regions abutting the vibrating surface, and leaving the overall temperature of the chemical solutions largely unchanged, is the effective agent in greatly increasing reaction rates.

In general the frequency of vibration may range from the infrasonic through the aural and into the ultrasonic frequency regimes. Because, in most cases, the vibrating elements are made of metal and the size of the apparatus producing the motion is designed to have a human dimension most equipment used in sonication employs ultrasonic frequencies of vibration. Use of lower frequencies, although entirely permissible, fall within the aural range of human hearing whose intensity can become intolerable to the human ears of those administering the apparatus and whose dimensions also become, as the frequency enters the lower range of hearing, very large. Use of infrasonic frequencies, while below the frequency threshold of human hearing, dictate the use of room sized equipment. However, sonication and its effects are not restricted by the frequency of vibration and may be used if practical circumstances comply over the range of sound frequencies, ranging from equipment tens of meters in size to those having dimensions of a few microns.

Of particular interest in this disclosure is the development of a sonicator easily used in household environments by people usually skilled in the use of simple tools and appliances such as hand held skin treatments and dental prophylactic appliances such as toothbrushes and dental whitening applicators. In particular, this invention is designed to accelerate using sonochemical induced reactions the whitening effect of existing dental bleaching solutions for teeth but the invention is not limited to dental uses and may find application in the treatment of wound healing or other epidermal treatments as well as a more convenient and, significantly, a very economical method of lysing biologic cell specimens for laboratory analysis without the need to buy the now expensive sonicating equipment available for this purpose, using only a handheld device instead of bench positioned equipment.

### DESCRIPTION OF THE INVENTION

The following explanations describe the vibrational performance of the invention and assume an understanding of the underlying technology possessed by a practitioner skilled in the art of the design of ultrasonic resonators and, as such, does not elaborate upon the design considerations dictated by the physical phenomena of extensional and flexural mechanical resonant vibration which determine the type of motion desired and the limits of the magnitude of the vibration.

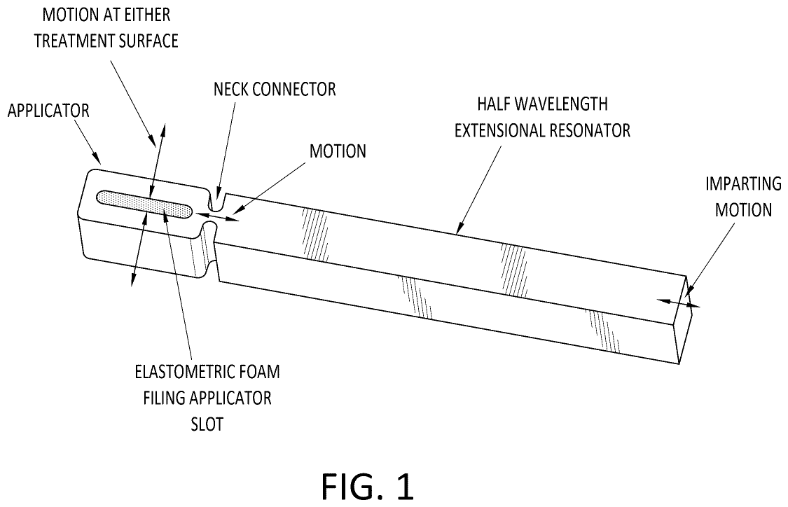

FIG. 1 illustrates the elements of the invention.

The wand is composed of two resonators, the first one being a prismatic half wavelength extensional resonator to which is imparted vibrational motion, whose direction is shown, at its free end. The second element, the applicator, is joined to the first through a neck connector. This element is a flexural resonator driven by motion imparted by the neck whose direction is shown. The direction of the motion of the applicator, as shown, is perpendicular to that of the neck. It is this motion that is exposed to a liquid medium present on the surface of the applicator and which causes the liquid to cavitate.

The slot in the applicator is filled with foam made of closed cellular material. This foam does not impede the motion of the applicator but it prevents the liquid medium from entering the slot which extends through the entire thickness of the applicator. If the liquid medium fills the slot region extraordinary heating of the medium is produced as the upper and lower surfaces of the slot radiate together into the narrow cavity, heating the liquid and the applicator to temperatures that can cause failure of the applicator's structure.

The wand can be made of any material capable of enduring the vibration needed. Typically for operation at an ultrasonic frequency of 50 kHz suitable materials are aluminum or titanium when the desired excursion of the applicator is the range of 10 to 50 microns. Although shown as one integral assembly the applicator element and the half wavelength extensional element may be made of different materials and may be joined together by any of the acceptable methods such as with a screw threaded joint, by welding or press fitting. Of prime importance is that the width of the joint between these elements be a fraction of the width of the applicator. For example if the applicator is 6 mm wide the joint should be no more than 1.5 mm wide if the desired flexural motion of the applicator is to be obtained.

Both the applicator and half wavelength extensional resonator are designed, each themselves, to be resonant at approximately the same frequency so that when joined they resonant together at the same frequency. As the flexural motion of the applicator is symmetrical, with both the lower and upper limbs move with identical but opposite motion, the flexural motion produced is not communicated to the half wavelength resonator and importantly is not communicated to the electro-mechanical transducer that imparts motion to the half wavelength extensional resonator at its free end, preventing such flexural motion from interfering with the production of the pure extensional motion desired to be imparted to the applicator.

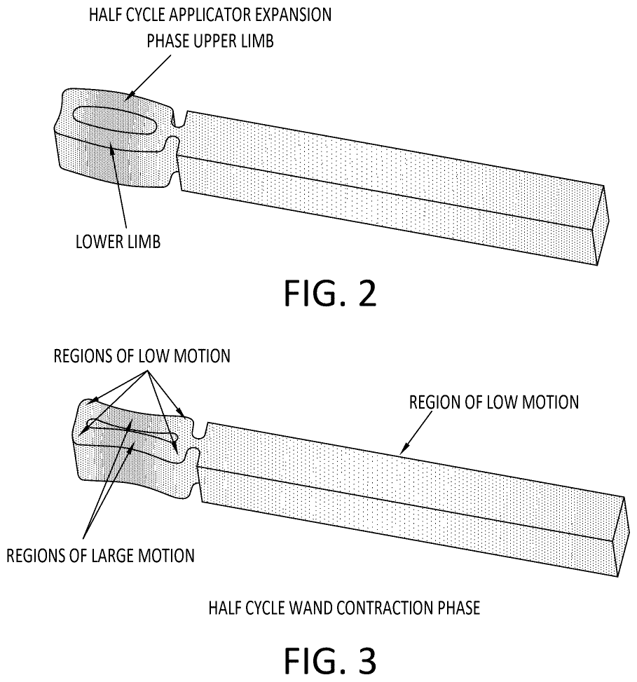

FIGS. 2 and 3 illustrate, with exaggeration, the motional shape of the applicator. FIG. 2 depicts the deformation of the applicator during the half cycle of vibration when its surfaces extend into the liquid medium in the compression part of the cycle. FIG. 3 depicts the deformation of the surfaces during the other half cycle when they retract from the liquid medium in the rarefaction part of the cycle.

In these figures regions of lower motion, also called nodes of motion are shown in dark blue while regions of large motion are shown in shades of yellow and red. Typically for motion imparted at the free end of the extension resonator the flexural motion produced in the applicator is between 2 and 10 times the extensional motion. This amplification of motion is determined by the dimensions of the applicator and in particular by the thickness of the upper and lower limbs that flex and the length of the slot. For example, the overall length of the slot may be increased while the thickness of limbs is also increased so as to keep the resonant frequency unchanged, with the result being that the motion of the limbs for given imparted extensional motion is reduced.

It is also possible to increase or reduce the motion of the applicator's surfaces by replacing the uniform prismatic extensional half wavelength resonator with a half wavelength extensional horn contoured to produce less motion where it is connected to the applicator for a given imparted motion produced by a connected electro-mechanical transducer.

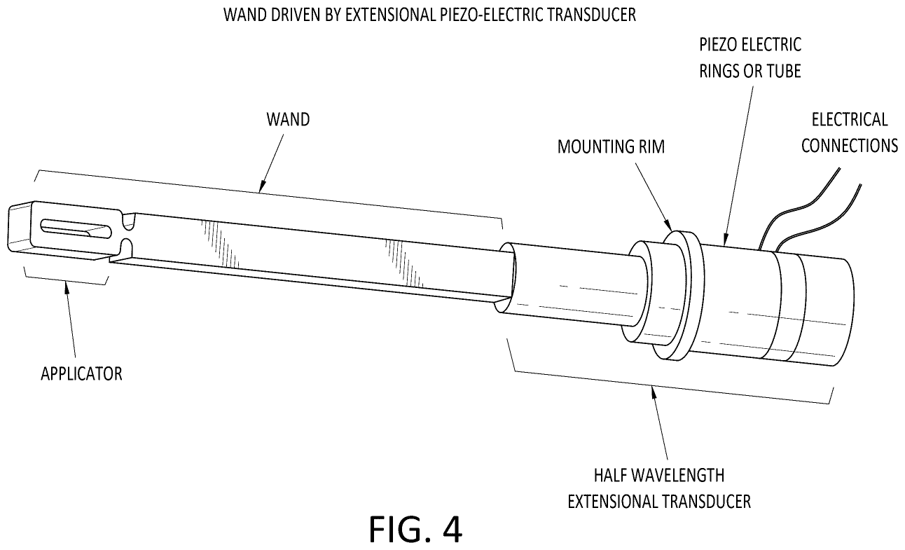

FIG. 4 shows the use of the wand with an electro-mechanical transducer providing the needed extensional motion. In particular the transducer shown utilizes piezo electric rings or a tube to produce through electrical excitation extensional motion. The transducer is designed to be resonate at the same frequency as the wand and is connected to the wand using any of the accepted joining methods such as screw threads, press-fitting, brazing or welding. The transducer also provides a mounting rim, located in region of low motion, suitable for engagement with a housing enveloping the entire structure excepting portions of the wand distant from the transducer. Such transducers are known as half wavelength extensional resonators and are commonly used in a variety of the applications including ultrasonic cell disrupters, plastic assembly and ultrasonic welding equipment.

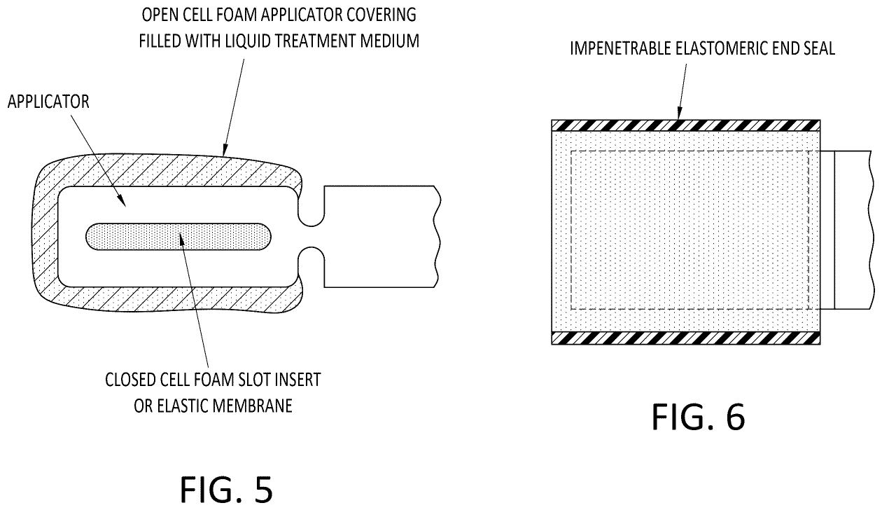

FIG. 5 illustrates an important administrative component for use with the wand. This item is a foam pocket surrounding the applicator and made of open cell material that permits the infusion of the treatment fluid into the foam. The vibration produced by the applicator is communicated to the fluid within the foam, producing cavitation and enhanced sonochemical reactions of the treatment fluid. Also shown is the foam slot insert which is made from closed cell elastomeric foam that prevents the treatment fluid from entering the slot and heating the applicator and open celled foam pocket. The slot openings may also be sealed with a membrane made of material such silicone room temperature vulcanizing rubber (RTV) or other suitable material. Intrusion of the whitening solution in the slot opening is not desired as it results in producing an intense load upon the vibrating sides of the slot.

To prevent the treatment fluid from escaping from the sides of the open cell foam covering, the sides of the foam may be sealed with an suitable elastic covering such as silicone or other suitable material as shown in FIG. 6. These seals help ensure that the treatment fluid remains within the open cell foam.

In this depiction, since the region of interest is the applicator and its foam attachments the rest of the wand beyond its connection to the extensional resonator is fore shortened.

In practice the open celled foam pocket is wetted with the treatment fluid and the applicator placed in contact with a target object, with the object in the preferred embodiment being human epidermis or teeth. The treatment fluid itself may be a solution of hydrogen peroxide, a bleaching solution, or medicinal fluids that infuse through the teeth gums or skin. The treatment time may amount to a few minutes of exposure to the vibration activated fluid and standard methods of replenishing this fluid during the treatment, well known in art, such as a gravity or pumped supply of fluid administered in drips may be incorporated if necessary.

1. A dental treatment device, comprising:
a wand including an applicator;
a neck connector provided between the wand and the applicator;
an ultrasonic resonator; and
the ultrasonic resonator generates ultrasonic vibration in the applicator, the applicator generating ultrasonic vibration of a surface of an open cell foam, the open cell foam being impregnated with a solution and placed in contact with a surface of an individual human tooth.

2. A dental treatment device as set forth in claim 1, wherein:
the open cell foam includes a foam sleeve surrounding the applicator.

3. A dental treatment device as set forth in claim 2, wherein:
the open cell foam sleeve is detachably attached to the applicator.

4. A dental treatment device as set forth in claim 1, wherein:
the wand includes two resonators.
